(19) United States
(12) Patent Application Publication
(10) Pub. No.: US 2021/0294330 A1
(43) Pub. Date: Sep. 23, 2021

(54) MOVING ROBOT AND FOLLOWING SETTING METHOD THEREOF

(71) Applicant: LG ELECTRONICS INC., Seoul (KR)

(72) Inventors: Kyoungsuk KO, Seoul (KR); Byungjin KIM, Seoul (KR); Sungwook LEE, Seoul (KR); Hyungsub LEE, Seoul (KR); Koh CHOI, Seoul (KR)

(73) Assignee: LG ELECTRONICS INC., Seoul (KR)

(21) Appl. No.: 17/266,457

(22) PCT Filed: Jul. 16, 2019
(86) PCT No.: PCT/KR2019/008801

§ 371 Date: Feb. 5, 2021

Related U.S. Application Data
(60) Provisional application No. 62/714,746, filed on Aug. 5, 2018.

(30) Foreign Application Priority Data
Jun. 11, 2019 (KR) 10-2019-0068832

(51) Int. Cl. G05D 1/02; G05D 1/00

(52) U.S. Cl. CPC G05D 1/028; G05D 1/0016; G05D 1/0295

(57) ABSTRACT

A moving robot according to an embodiment of the present disclosure includes a traveling unit to move a main body thereof, a communication unit to perform communication with a controller using signals, and a controller to calculate a signal distance between the controller and the main body in response to reception of a first signal from the controller, and controls the traveling unit so that the main body moves while following the controller when the calculated signal distance is within a predetermined range. The control unit calculates a signal distance between the controller and the main body in response to reception of a second signal from the controller while the main body is following the controller, and releases the follow-up travel of the main body when the calculated signal distance is within a predetermined range.

### CROSS-REFERENCE TO RELATED APPLICATIONS

This application is the National Stage filing under 35 U.S.C. 371 of International Application No. PCT/KR2019/008801, filed on Jul. 16, 2019, which claims the benefit of earlier filing date and right of priority to U.S. Provisional Application No. 62/714,746 filed Aug. 5, 2018 and Korean Application No. 10-2019-0068832, filed on Jun. 11, 2019, the contents of which are all hereby incorporated by reference herein in their entirety.

### FIELD

The present disclosure relates to a moving robot and a tracking setting method thereof, and more particularly, to a tracking setting method using a controller.

### BACKGROUND

Generally, a moving robot is a device that automatically performs a predetermined operation while traveling by itself in a predetermined range without a user's operation. The moving robot senses obstacles located in the area and performs its operations by moving close to or away from such obstacles.

Such a moving robot may provide various services such as cleaning, carrying goods, guiding the road, etc. while traveling in a specific area.

In order to provide such services, there is a growing need for developing a moving robot which is capable of performing tasks while following a user's position, or a plurality of moving robots that one performs tasks while following another. For example, a moving robot for a cart may be equipped with a following (or tracking) function to provide recognition guidance, storage of purchased goods, payment function, and the like, while following a customer who is shopping.

The prior art document WO2017-036532 discloses a method in which a master robot cleaner (hereinafter, referred to as a master robot) controls at least one slave robot cleaner (hereinafter, referred to as a slave robot).

The prior art document discloses a configuration in which the master robot detects adjacent obstacles by using an obstacle detection device and determines its position related to the slave robot using position data derived from the obstacle detection device.

According to the prior art, since the master robot and the slave robot are already set and the master robot determines the position (location) of the slave robot, there is a limitation in using the tracking function easily by anyone. For example, when the roles of the master robot and the slave robot are to be switched or when a follow-up (following or tracking) control is released and then reset, it is not easy to set and release the follow-up control.

In addition, there is a limitation in expanding the following (tracking) function by connecting three more moving robots and making one follow another according to a preset order.

### SUMMARY

### Technical Problem

Therefore, one aspect of the present disclosure is to provide a moving robot, capable of facilitating setting or release of a following (or tracking) function, by which a moving robot follows a user or one of a plurality of moving robots follows another, and a follow-up setting method thereof.

Another aspect of the present disclosure is to provide a moving robot, capable of easily setting following (or tracking) relationship among three or more moving robots and easily releasing the following relationship of a specific moving robot or all the moving robots, and a follow-up setting method thereof.

Still another aspect of the present disclosure is to provide a moving robot, capable of quickly executing follow-up setting and follow-up release with respect to a moving robot using wireless communication with a controller, and a follow-up setting method thereof.

### Technical Solution

To achieve those aspects and other advantages according to an embodiment of the present disclosure, there is provided a moving robot including a traveling unit to move a main body thereof, a communication unit to perform communication with a controller using signals, and a control unit to calculate a signal distance between the controller and the main body in response to reception of a first signal from the controller, and control the traveling unit so that the main body moves while following the controller when the calculated signal distance is within a predetermined range, wherein the control unit calculates a signal distance between the controller and the main body in response to reception of a second signal from the controller while the main body is following the controller, and releases the follow-up travel of the main body when the calculated signal distance is within a predetermined range.

In one embodiment, the communication unit may receive the first signal and the second signal using at least one of an Ultra-wideband (UWB) module and a Bluetooth (BT) module.

In one embodiment, the communication unit may further include a plurality of antennas, and the control unit may recognize a position of the controller based on the first signal received through at least one of the UWB module and the BT module and the plurality of antennas, and control the traveling unit to move while following the recognized position.

In one embodiment, the control unit may control the communication unit to transmit a response signal to the first signal to the controller when the calculated signal distance is within the predetermined range, and start the follow-up travel of the main body, in response to reception of a third signal corresponding to a follow-up command from the controller that has received the response signal.

In one embodiment, the control unit may release the follow-up travel of the main body when the signal distance between the main body and the controller exceeds a preset threshold distance while the main body is following the controller.

In one embodiment, the control unit may stop the travel of the main body until the signal distance between the main body and the controller exceeds a predetermined stop distance, in response to the signal distance being reduced to be shorter than the predetermined stop distance, while the main body is following the controller.

To achieve these aspects and other advantages according to an embodiment of the present disclosure, there are provided a plurality of moving robots, including a first moving robot and a second moving robot that perform communication with a controller using signals. The first moving robot may calculate a signal distance from the controller in response to reception of a signal from the controller, and pair with the controller when the calculated signal distance is within a predetermined range. The second moving robot may calculate a signal distance from the controller in response to reception of a signal from the controller, pair with the controller when the calculated signal distance is with a predetermined range, and receive pairing address information regarding the first moving robot from the controller, so as to move while following the first moving robot. The first moving robot may receive pairing address information regarding the second moving robot from the controller, so as to perform communication with the second moving robot after pairing with the second moving robot.

In one embodiment, the first moving robot may be restricted from following the controller while the controller is moving toward the second moving robot after the first moving robot and the controller are paired.

In one embodiment, the first moving robot may periodically broadcast a beacon signal to perform communication with the second moving robot, after receiving the pairing address information regarding the second moving robot from the controller.

In one embodiment, a third moving robot may calculate a signal distance from the controller upon receiving a signal from the controller while the second moving robot is following the first moving robot, pair with the controller when the calculated signal distance is within a predetermined range, and receive pairing address information regarding the second moving robot from the controller, so as to move while following the second moving robot. The second moving robot may receive pairing address information regarding the third moving robot from the controller.

In one embodiment, the second moving robot may calculate a signal distance from the controller when a second signal is received from the controller while the third moving robot is following the second moving robot and the second moving robot is following the first moving robot, and release the follow-up travel of the second moving robot with respect to the first moving robot when the calculated signal distance is within a predetermined range.

In one embodiment, when the follow-up travel of the second moving robot is released, the second moving robot may transmit pairing address information regarding the first moving robot to the third moving robot, and transfer the pairing address information regarding the third moving robot to the first moving robot. The third moving robot may move while following the first moving robot when a signal distance between the first moving robot and the third moving robot is within a predetermined range.

In one embodiment, the first moving robot may calculate a signal distance from the controller upon receiving a second signal from the controller, and release pairing of the first moving robot when the calculated signal distance is within a predetermined range. The follow-up travel of the second moving robot with respect to the first moving robot may be released when the pairing of the first moving robot is released.

To achieve these aspects and other advantages according to an embodiment of the present disclosure, there is provided a method for controlling a moving robot capable of communicating with a controller, the method including receiving a first signal from the controller, calculating a signal distance between the controller and the moving robot, controlling the moving robot to move while following the controller when the calculated signal distance is within a predetermined range, receiving a second signal from the controller while the moving robot is following the controller, calculating a signal distance between the controller and the moving robot, and controlling the follow-up travel of the moving robot to be released when the calculated signal distance is within a predetermined range.

To achieve these aspects and other advantages according to an embodiment of the present disclosure, there is provided a method for controlling a plurality of moving robots including a first moving robot and a second moving robot that communicate with a controller using signals, the method including calculating, by the first moving robot, a signal distance from the controller in response to reception of a signal from the controller, and performing pairing with the controller when the calculated signal distance is within a predetermined range, calculating, by the second moving robot, a signal distance from the controller in response to reception of a signal from the controller, and performing pairing with the controller when the calculated signal distance is within a predetermined range, receiving, by the second moving robot, pairing address information regarding the first moving robot from the controller so that the second moving robot moves while following the first moving robot, receiving, by the first moving robot, pairing address information regarding the second moving robot from the controller, so as to perform communication with the second moving robot, and moving, by the second moving robot, while following the first moving robot when the first moving robot moves.

### Advantageous Effects

As described above, in a moving robot and a follow-up setting method thereof according to an embodiment of the present disclosure, it may be possible to quickly and easily set a function for making a moving robot follow a user who controls a controller and release the set following function. Even if a third moving robot is added in a state where following relationship is established among a plurality of moving robots, the following relationship is performed between a first moving robot and a second moving robot, and between the second moving robot and the third moving robot, which may facilitate an additional follow-up setting for any number of moving robots. Further, follow-up setting for a part of a plurality of moving robots which are in following relationship can be released or a target or order to follow in the set following relationship can be changed quickly and easily.

### BRIEF DESCRIPTION OF THE DRAWINGS

FIG. 1A is a perspective view illustrating one example of a mobile robot, namely, a moving robot for a cart, in accordance with the present disclosure.

FIG. 1B is a view illustrating a state in which the moving robot for the cart and a controller perform communication with each other, and FIG. 1C is an exemplary block diagram illustrating a detailed configuration of the moving robot and the controller.

FIG. 2A is a view illustrating follow-up (following or tracking) travel among a plurality of moving robots in accordance with one embodiment of the present disclosure.

FIG. 2B is a conceptual view illustrating network communication between a plurality of moving robots and a controller in accordance with one embodiment of the present disclosure, and FIG. 2C is a view illustrating an Angle of Arrival (AoA) positioning technique related to a tracking (or following) function in accordance with the present disclosure.

FIG. 3 is a representative flowchart illustrating a tracking setting and releasing method for a moving robot in accordance with one embodiment of the present disclosure, and FIGS. 4A and 4B are exemplary conceptual views illustrating respective processes of FIG. 3 in detail.

FIG. 5 is a representative flowchart illustrating a tracking setting method for a plurality of moving robots in accordance with another embodiment of the present disclosure, and FIGS. 6A to 6C are exemplary conceptual views illustrating respective processes of FIG. 5 in detail.

FIGS. 7A and 7B are conceptual vies illustrating a following (or tracking) control of a plurality of moving robots in accordance with an embodiment of the present disclosure.

FIGS. 8A to 8E and 9A to 9D are conceptual views illustrating different examples of releasing tracking setting for at least some of a plurality of moving robots in a following relationship.

### DETAILED DESCRIPTION

Hereinafter, a moving robot according to the present disclosure will be described in detail with reference to the accompanying drawings.

Hereinafter, description will be given in detail of embodiments disclosed herein. Technical terms used in this specification are merely used for explaining specific embodiments, and should not be constructed to limit the scope of the technology disclosed herein.

First, the term “moving robot” disclosed herein may be used as the same meaning as “robot (for a specific function)” that can autonomously travel, “mobile robot,” “moving robot for a cart,” “cart robot,” “autonomous cart,” and “smart cart,” and those terms will be used equally.

Furthermore, the term “a plurality of moving robots” disclosed herein may be used as “a plurality of robots (for a specific function),” “a plurality of carts,” “a plurality of autonomous carts,” or the like. Furthermore, the term “first moving robot” may be named “first robot”, or “first cart.” The term “second moving robot” may also be named “second robot” or “second cart.”

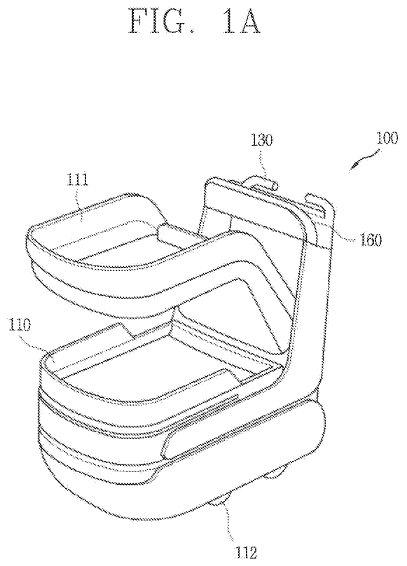

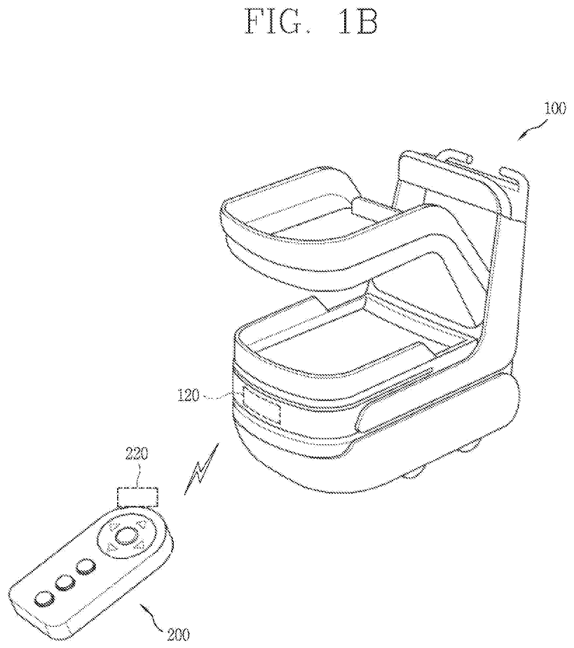

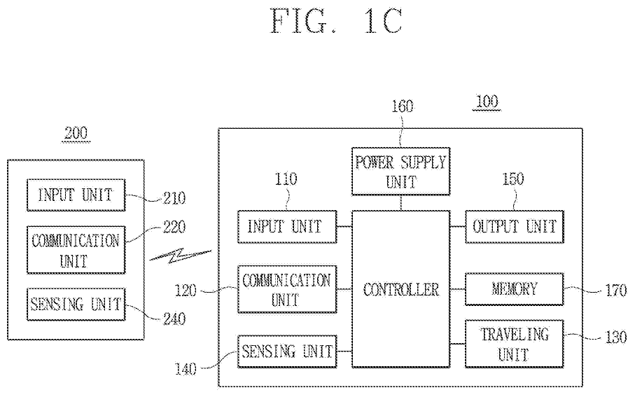

FIG. 1 is a perspective view illustrating one example of a mobile robot, namely, a moving robot for a cart, in accordance with the present disclosure. FIG. 1B is a view showing a state in which the cart moving robot shown in FIG. 1A is in communication with a controller, and FIG. 1C is an exemplary block diagram showing a detailed configuration of a moving robot and a controller.

Referring to FIG. 1A, a moving robot according to the present disclosure may include, for example, a moving robot main body 110, a shelf unit 111, a wheel unit 112, a handle 130, an operation unit 160, a display (not shown), and the like. The moving robot main body 110 is provided with various components, including a control unit (not shown), mounted therein for controlling the moving robot 100.

The moving robot main body 100 may be moved or rotated forward, backward, to left and to right by the wheel unit 111. The wheel unit 111 may include a plurality of main wheels and a sub wheel.

The plurality of main wheels is provided on both sides of the moving robot main body 110 and configured to be rotatable in one direction or another direction according to a control signal of the control unit. Each of the main wheels may be configured to be driven independently of each other. To this end, the control unit controls the operation of the wheel unit 111.

Meanwhile, the moving robot main body 110 is provided with a battery (not shown) for supplying power to the moving robot 100. The battery may be configured to be rechargeable, and may be detachably disposed in a bottom portion of the moving robot main body 110.

In addition, the moving robot main body 110 may be provided with a sensing unit. For example, the sensing unit may be disposed on the front of the moving robot main body 110 to detect obstacles or features existing on a travel path. In addition, the sensing unit may be configured to further perform other sensing functions in addition to such detecting function, and may include, for example, a camera for acquiring surrounding images. Also, the sensing unit 110 may sense presence of a docking device that performs battery charging of the moving robot main body 110.

The shelf unit 111 may store and/or keep items (goods, stuffs). In addition, the shelf unit 111 may include sensors, a display, and a communication unit for identifying the stored and/or kept items, confirming the identified items, and paying for the confirmed items. In this case, an operation for providing a service for identifying, confirming, and paying for the items placed on the shelf unit 111 can be performed by a control command received from the control unit.

The handle 130 is provided at a position corresponding to positions of both hands of the user. The user can move the moving robot main body 110 by applying an external force to the handle 130 while the moving robot main body 110 does not autonomously travel. In addition, while the moving robot main body 110 is autonomously traveling, the handle 130 may function as a walking assistance element so that the user can easily walk along a path guided by the moving robot whiling gripping the handle 130.

The operation unit 160 receives various control commands for the moving robot from the user. The operation unit 160 may include one or more buttons, or may be configured in the form of a touch screen layered with a touch sensor.

Continuously referring to FIG. 1B, the moving robot 100 according to the present disclosure may perform wireless communication with a control device (or controller) 200 through a communication unit 120. Specifically, a control signal transmitted through a communication unit 220 of the control device (or controller) 200 may be received by a communication unit 120 of the moving robot, and an operation corresponding to the received control signal may be performed. A response signal transmitted through the communication module 120 of the moving robot 100 may be received by the communication module 220 of the control device (or controller) 200 and processed so as to generate a corresponding control signal. Also, the moving robot 100 and the control device 200 may be paired with each other by exchanging signals through their communication modules 120 and 220.

FIG. 1C is an exemplary block diagram illustrating a detailed configuration of the moving robot and the control device of FIG. 1B.

First, a moving robot 100 according to one embodiment of the present disclosure may include at least one of an input unit 120, a communication module 120, a traveling unit 130, a sensing unit 140, an output unit 150, a power supply unit 160, a memory 170, a control unit 1800, and a cleaning unit 180, or a combination thereof.

At this time, those components shown in FIG. 1C are not essential, and a moving robot having greater or fewer components can be implemented. Also, as described above, each of a plurality of moving robots described in the present disclosure may equally include only some of components to be described below. That is, a plurality of moving robots may include different components.

Hereinafter, each component will be described.

First, the power supply unit 160 includes a battery that can be charged by an external commercial power supply, and supplies power to the mobile robot. The power supply unit 160 supplies driving force to each of the components included in the moving robot to supply operating power required for the moving robot to travel or perform a specific function.

For this, the control unit 180 detects the remaining power level of the battery. When the remaining power is insufficient, the control unit 180 may control the moving robot to move to a charging station connected to the external commercial power supply, so that the battery can be charged by receiving currents from the charging base. The battery may be connected to a battery sensing portion so that a remaining power level and a charging state can be transmitted to the control unit 180. The output unit 150 may display the remaining battery level on the display unit.

The control unit 180 performs processing of information based on an artificial intelligence (AI) technology and may include one or more modules that perform at least one of learning of information, inference of information, perception of information, and processing of natural language.

The control unit 180 may use a machine learning technology to perform at least one of learning, inference and processing of a large amount of information (big data), such as information stored in the cleaner, environmental information around the moving robot, information stored in an external storage capable of performing communication, and the like. Furthermore, the control unit 180 may predict (or infer) at least one executable operation of the cleaner based on information learned using the machine learning technology, and control the moving robot to execute the most feasible operation among the at least one predicted operation.

The machine learning technology is a technology that collects and learns a large amount of information based on at least one algorithm, and determines and predicts information based on the learned information. The learning of information is an operation of grasping characteristics of information, rules and judgment criteria, quantifying a relation between information and information, and predicting new data using the quantified patterns.

Algorithms used by the machine learning technology may be algorithms based on statistics, for example, a decision tree that uses a tree structure type as a prediction model, an artificial neural network that mimics neural network structures and functions of living creatures, genetic programming based on biological evolutionary algorithms, clustering of distributing observed examples to a subset of clusters, a Monte Carlo method of computing function values as probability using randomly-extracted random numbers, and the like.

As a field of machine learning technology, deep learning is a technique that performs at least one of learning, judging, and processing of information using an Artificial Neural Network (ANN) or a Deep Neuron Network (DNN) algorithm. The deep neural network (DNN) may have a structure of linking layers and transferring data between the layers. This deep learning technology may be employed to learn a vast amount of information through the deep neural network (DNN) using a graphic processing unit (GPU) optimized for parallel computing.

The control unit 180 may use training data stored in an external server or memory, and may include a learning engine mounted to detect characteristics for recognizing a predetermined object. At this time, the characteristics for recognizing the object may include a size, shape and shade of the object.

The learning engine may be mounted on the control unit 180 or on an external server. When the learning engine is mounted on an external server, the control unit 180 may control the communication unit 120 to transmit at least one image to be analyzed, to the external server.

The traveling unit 130 may include a motor, and operate the motor to bidirectionally rotate left and right main wheels, so that the main body can rotate or move. At this time, the left and right main wheels may be independently moved. The traveling unit 130 may advance the main body of the moving robot forward, backward, left, right, curvedly, or in place.

On the other hand, the input unit 110 receives various control commands for the moving robot from the user. The input unit 110 may include one or more buttons, for example, the input unit 1200 may include an OK button, a setting button, and the like. The OK button is a button for receiving a command for confirming detection information, obstacle information, position information, and map information from the user, and the setting button is a button for receiving a command for setting those information from the user. In addition, the input unit 110 may be implemented as a hard key, a soft key, a touch pad, or the like and may be disposed on a top of the moving robot. For example, the input unit 110 may implement a form of a touch screen together with the output unit 150.

The output unit 150 may display a battery state, an operation state, a travel mode, an executable menu, and the like on the screen. The output unit 150 may output internal status information of the moving robot detected by the sensing unit 140, for example, a current status of each component included in the moving robot. The output unit 150 may also display external status information detected by the sensing unit 140, obstacle information, position information, map information, item information and the like on the screen. The output unit 150 may be configured as one device of a light emitting diode (LED), a liquid crystal display (LCD), a plasma display panel, and an organic light emitting diode (OLED).

The output unit 150 may further include an audio output module for audibly outputting information related to an operation of the moving robot executed by the control unit 180 or an operation result. For example, the output unit 150 may output a warning sound to the outside in accordance with a warning signal generated by the control unit 180.

In this case, the audio output module (not shown) may be means, such as a beeper, a speaker or the like for outputting sounds, and the output unit 150 may output sounds to the outside through the audio output module using audio data or message data having a predetermined pattern stored in the memory 170.

The memory 170 stores a control program for controlling or driving the moving robot and data corresponding thereto. The memory 170 may store audio information, image information, obstacle information, position information, map information, item information, and the like. Also, the memory 170 may store information related to a travel pattern.

The memory 170 mainly uses a nonvolatile memory. Here, the non-volatile memory (NVM, NVRAM) is a storage device that can continuously store information even when power is not supplied. Examples of the storage device include a ROM, a flash memory, a magnetic computer storage device (e.g., a hard disk, a diskette drive, a magnetic tape), an optical disk drive, a magnetic RAM, a PRAM, and the like.

On the other hand, the sensing unit 140 may include at least one of an external signal detection sensor, a front sensor, a cliff sensor, a two-dimensional (2D) camera sensor, and a three-dimensional (3D) camera sensor. Here, the external signal detection sensor may sense an external signal of a moving robot. The external signal sensor may be, for example, an infrared ray (IR) sensor, an ultrasonic sensor, a radio frequency (RF) sensor, a UWB sensor, an NFC sensor, or the like.

Meanwhile, the communication unit 120 is connected to other devices located in a specific area through one of a wired, wireless, and satellite communications to transmit and receive signals and data. The communication unit 120 may transmit and receive data with another device located in a specific area. In this case, the another device may be any device if it can transmit and receive data through a network. For example, the another device may be an air conditioner, a heating device, an air purifier, a lamp, a TV, a vehicle, and the like. The another device may also be a device for controlling a door, a window, a water supply valve, a gas valve, or the like. The another device may also be a sensor for detecting temperature, humidity, air pressure, gas, or the like.

Further, the communication unit 120 may communicate with another moving robot 100 located in a specific area or within a predetermined range. Further, the communication unit 120 may communicate with a controller 200 located in a specific area or within a predetermined range.

Continuously referring to FIG. 1C, the controller 200 communicating with the moving robot 100 may include an input unit 210, a communication unit 220, and a sensing unit 240.

The input unit 210 may include one or more buttons and a signal input through the input unit 210 may be received by the communication unit 120 of the moving robot 100 through the communication unit 220. Then, the moving robot 100 may transmit a response signal corresponding to the received signal or may perform an operation corresponding to the signal.

Referring to FIG. 1B, the moving robot 100 transmits a UWB signal through the communication unit (or communication module), for example, a UWB module 120 provided therein, to perform communication with the controller 200 with the UWB module (or communication unit) 220. The moving robot 100 performs communication with the controller 200 by receiving the UWB signal received from the UWB module 220 of the controller 200.

Referring to FIG. 1C, the controller 200 may further include a sensing unit 240 in addition to the communication unit 220. The sensing unit 240 may further include a gyro sensor and a distance measuring sensor, for example.

The gyro sensor may detect a change in a three-axis value according to the movement of the controller 200. Specifically, the gyro sensor may detect an angular velocity according to the movement of the controller 200 by which at least one of x, y and z-axis values is changed.

Also, the gyro sensor may use x, y, and z axis values, which are detected at a specific time point, as a reference point, and detect x′, y′, and z′ axis values that change with respect to the reference point after reception of a predetermined input/a lapse of a predetermined period of time. To this end, the controller 200 may further include a magnetic sensor (not shown) and an acceleration sensor (not shown) as well as the gyro sensor.

The distance measuring sensor may emit at least one of a laser light signal, an IR signal, an ultrasonic signal, a carrier frequency, and an impulse signal, and may calculate a distance from the controller 200 to the corresponding signal based on a reflected signal. That is, it is possible to calculate a signal distance of a signal to be exchanged with the moving robot.

To this end, the distance measuring sensor may include, for example, a time of flight (ToF) sensor. For example, the ToF sensor may include a transmitter that emits an optical signal transformed to a specific frequency, and a receiver that receives and measures a reflected signal. When the ToF sensor is installed on the controller 200, the transmitter and the receiver may be spaced apart from each other to avoid signal affection therebetween.

Also, the terminal 200 may determine the location of the moving robot using Ultra-wide Band (UWB) technology.

In detail, the communication unit 220, namely, the UWB module of the terminal 200 may operate as ‘UWB tag’ that emits a UWB signal, and the communication unit 120, namely, the UWB module of the moving robot 100 may operate as ‘UWB anchor’ that receives a UWB signal.

The distance measuring sensor may calculate a distance between the moving robot 100 and the controller 200 by using a distance measuring technology such as ToF (Time of Flight) technology.

Specifically, a first UWB signal, which is emitted from the controller 200, is transmitted to the moving robot 100. The first UWB signal may be received through the UWB anchor of the moving robot 100. The moving robot 100 which has received the first UWB signal transmits a response signal to the controller 200. Then, the terminal 200 may transmit a second UWB signal, which is a response signal, to the moving robot 100

Here, the second UWB signal may include delay time information which is calculated based on a time at which the response signal has been received and a time at which the second UWB signal has been transmitted responsive to the response signal. The control unit of the moving robot 100 may calculate a distance between the moving robot 100 and the remote controller 200, based on a time at which the response signal has been transmitted, a time at which the second UWB signal has been arrived at the UWB anchor of the moving robot 100, and the delay time information included in the second UWB signal.

$$Distance = c * \frac{{t}_{2} - {t}_{1} - {t}_{reply}}{2}$$

Here, t₂ denotes an arrival time of the second UWB signal, t₁ denotes a transmission time of the response signal, t_{reply} denotes a delay time, and c denotes a constant value indicating a speed of light.

As such, the distance between the moving robot 100 and the controller 200 can be determined by measuring a time difference between signals transmitted and received between the UWB tag and the UWB anchor included in the moving robot 100 and the controller 200, respectively.

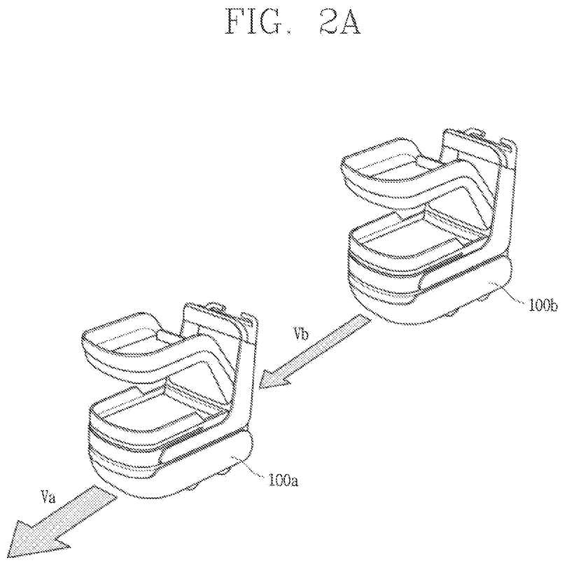

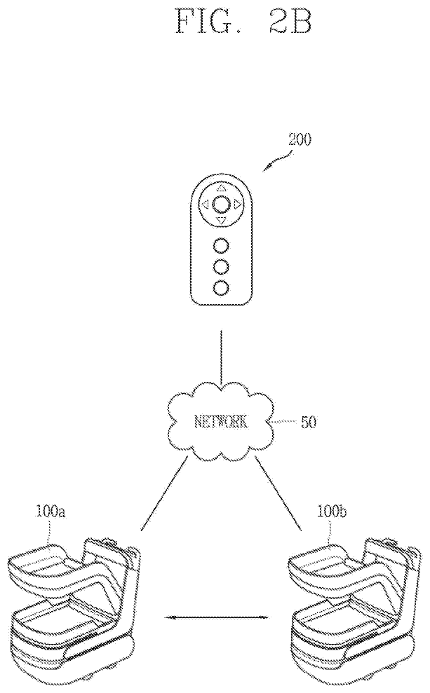

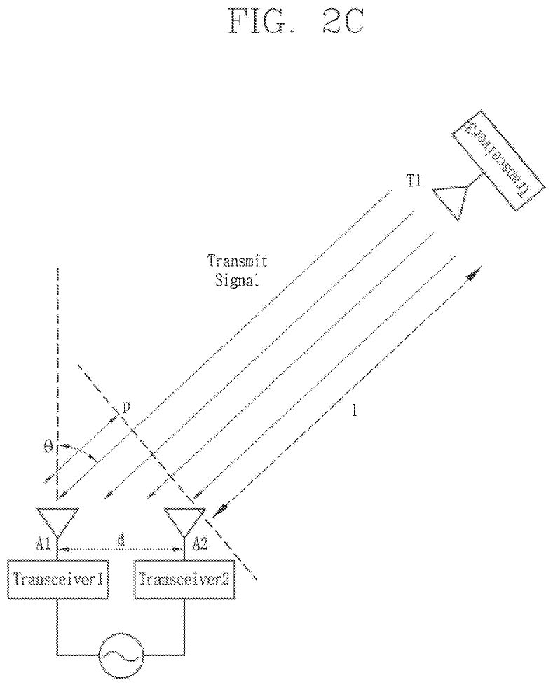

FIG. 2A illustrates a tracking (or following) control between a plurality of moving robots, and FIG. 2B is a conceptual view illustrating network communication between the plurality of moving robots and a controller.

Referring to FIG. 2A, the first moving robot 100a may control the second moving robot 100b such that the second moving robot 100b follows the first moving robot 100a.

For this purpose, the first moving robot 100a and the second moving robot 100b may exist in a specific area where they can communicate with each other, and the second moving robot 100b may recognize at least a relative position of the first moving robot 100a.

For example, the communication unit of the first moving robot 100a and the communication unit of the second moving robot 100b exchange IR signals, ultrasonic signals, carrier frequencies, UWB signals, BT signals, and the like, and analyze them through triangulation, so as to calculate movement displacements of the first moving robot 100a and the second moving robot 100b, thereby recognizing relative positions of the first moving robot 100a and the second moving robot 100b. However, the present disclosure is not limited to this method, and one of the various wireless communication technologies described above may be used to recognize the relative positions of the first moving robot 100a and the second moving robot 100b.

The second moving robot 100b may travel along a travel path of the first moving robot 100a. However, the traveling directions of the first moving robot 100a and the second moving robot 100b do not always coincide with each other. For example, when the first moving robot 100a moves or rotates up/down/right/left, the second moving robot 100b may move or rotate up/down/right/left after a predetermined time, and thus current advancing directions of the first and second moving robots 100a and 100b may differ from each other.

Also, a traveling speed Va of the first moving robot 100a and a traveling speed Vb of the second moving robot 100b may be different from each other. A traveling speed Vb of the first moving robot 100a and the second moving robot 100b may be varied in consideration of a communication-available distance between the first moving robot 100a and the second moving robot 100b.

For example, if the first moving robot 100a and the second moving robot 100b move away from each other by a predetermined distance or farther, the traveling speed Vb of the second moving robot 100b may become faster than before. On the other hand, when the first moving robot 100a and the second moving robot 100b move close to each other by a predetermined distance or nearer, the traveling speed Vb of the second moving robot 100b may become slower than before or the second moving robot 100b may stop for a predetermined time. Accordingly, the second moving robot 100b can keep following the first moving robot 100a while maintaining a predetermined distance.

Continuously referring to FIG. 2B, the first moving robot 100a and the second moving robot 100b may exchange data with each other through a network 50. In addition, the first moving robot 100a and/or the second moving robot 100b that perform autonomous traveling may perform a cleaning related operation or a corresponding operation by a control command received from the controller 200 through the network communication 50 or other communication.

In other words, although not shown, a plurality of moving robots 100a, 100b that perform autonomous traveling may also perform communication with the controller 200 through a first network communication and perform communication with each other through a second network communication.

Here, the network communication 50 may refer to short-range communication using at least one of wireless communication technologies, such as a wireless LAN (WLAN), a wireless personal area network (WPAN), a wireless fidelity (Wi-Fi) Wi-Fi direct, Digital Living Network Alliance (DLNA), Wireless Broadband (WiBro), World Interoperability for Microwave Access (WiMAX), Zigbee, Z-wave, Blue-Tooth (BT), Radio Frequency Identification (RFID), Infrared Data Association (IrDA), Ultrawide-Band (UWB), Wireless Universal Serial Bus (USB), and the like.

The network communication 50 may vary depending on a communication mode of the moving robots desired to communicate with each other.

In FIG. 2B, the first moving robot 100a and/or the second moving robot 100b that perform autonomous traveling may provide information sensed by the respective sensing units thereof to the controller 200 through the network communication 50. The controller 200 may also transmit a control command generated based on the received information to the first moving robot 100a and/or the second moving robot 100b via the network communication 50.

In FIG. 2B, the communication unit of the first moving robot 100a and the communication unit of the second moving robot 100b may also directly communicate with each other or indirectly communicate with each other via another router (not shown), to recognize information related to a traveling state and positions of counterparts.

In one example, the second moving robot 100b may perform a traveling operation according to a control command received from the first moving robot 100a. In this case, it may be said that the first moving robot 100a operates as a master and the second moving robot 100b operates as a slave. Alternatively, it may be said that the second moving robot 100b follows the first moving robot 100a.

Meanwhile, the moving robots 100a and 100b and the controller 200 according to the present disclosure may include the UWB modules (or UWB sensors), and may communicate with each other through the respective UWB modules (or UWB sensors).

The UWB module (or UWB sensor) may be included in the communication units 120 and 220 of the first moving robot 100a and the second moving robot 100b. In view of the fact that the UWB modules are used to sense the relative positions of the first moving robot 100a and the second moving robot 100b, the UWB modules may be included in the sensing units 140 and 240 of the first moving robot 100a and the second moving robot 100b.

For example, the first moving robot 100a may include a transmitting UWB module for transmitting UWB signals. The transmitting UWB module may be termed as a second type transmitting sensor or “UWB tag.”

Furthermore, the second moving robot 100b may include a receiving UWB module for receiving UWB signals output from the UWB module provided in the first moving robot 100a. The receiving UWB module may be named as a second type receiving sensor or a “UWB anchor.”

UWB signals transmitted/received between the UWB modules may be smoothly transmitted and received within a specific space. Accordingly, even if an obstacle exists between the first moving robot 100a and the second moving robot 100b, if the first moving robot 100a and the second moving robot 100b exist within a specific space, they can transmit and receive the UWB signals.

The first moving robot and the second moving robot may measure the time of a signal transmitted and received between the UWB tag and the UWB anchor to determine a spaced distance between the first moving robot 100a and the second moving robot 100b.

Specifically, for example, each of the plurality of moving robots 100a, 100b may be provided with one UWB sensor, or the first moving robot 100a may be provided with a single UWB sensor, and the second moving robot 100b following the first moving robot 100a may be provided with a single UWB sensor and at least one antenna or provided with at least two UWB sensors, so that the first moving robot 100a can measure distances to the second moving robot 100b at two different time points (t1, t2).

The UWB sensor of the first moving robot 100a and the UWB sensor of the second moving robot 100b radiate UWB signals to each other, and measure distances and relative speed using Time of Arrival (ToA), which is a time that the signals come back by being reflected from the robots. However, the present disclosure is not limited to this, and may recognize the relative positions of the plurality of cleaners 100a, 100b using a Time Difference of Arrival (TDoA) or Angle of Arrival (AoA) positioning technique.

Hereinafter, an Angle of Arrival (AoA) positioning technology will be described with reference to FIG. 2C.

Specifically, description will be given of a method of determining the relative positions of the first moving robot 100a and the second moving robot 100b using an AoA positioning technique. In order to use the AoA (Angle of Arrival) positioning technique, each of the first moving robot 100a and the second moving robot 100b should be provided with one receiver antenna or a plurality of receiver antennas.

The first moving robot 100a and the second moving robot 100b may determine their relative positions using a difference of angles that the receiver antennas provided in the cleaners, respectively, receive signals. To this end, each of the first moving robot 100a and the second moving robot 100b must be able to sense an accurate signal direction coming from the receiver antenna array. Since signals, for example, UWB signals, generated in the first moving robot 100a and the second moving robot 100b, respectively, are received only in specific directional antennas, they can determine (recognize) received angles of the signals.

Under assumption that positions of the receiver antennas provided in the first moving robot 100a and the second moving robot 100b are known, the relative positions of the first moving robot 100a and the second moving robot 100b may be calculated based on signal receiving directions of the receiver antennas. At this time, if one receiver antenna is installed, a 2D position may be calculated in a space of a predetermined range. On the other hand, if at least two receiver antennas are installed, a 3D position may be determined. In the latter case, a distance d between the receiver antennas is used for position calculation in order to accurately determine a signal receiving direction.

Referring to FIG. 2C, the UWB anchor includes antennas A1 and A2 in a first transceiver and a second transceiver, respectively, for receiving UWB signals. The UWB tag T1 transmits the UWB signals through an antenna of a third transceiver (Transmit Signal). Then, the first antenna A1 and the second antenna A2 of the UWB anchor receive the UWB signals.

At this time, if a distance I between the UWB anchor and the UWB tag T1 is longer than a spaced distance d between the first antenna A1 and the second antenna A2 provided in the UWB anchor, an incident shape as shown in FIG. 2C is shown if the transmitted UWB signals are in the form of a plane wave.

Therefore, a distance difference is caused between the UWB signals incident on the first antenna A1 and the second antenna A2. The distance difference corresponds to p in FIG. 2C. An angle formed by a first line connecting the first antenna A1 and the second antenna A2 and a second line orthogonal to the first line is θ. Therefore, the angle θ may be calculated through the following Equation 1.

$$p = d sin θ \\ sin θ = \frac{p}{d} \qquad [ Equation 1 ]$$

Meanwhile, the distance between the first antenna A1 or the second antenna A2 and the UWB tag T1 may be measured using two-way ranging. Two-way ranging is a method in which a transmitter and a receiver share their own time information while exchanging signals several times so as to eliminate a time error and thus measure a distance.

When the spaced distance 1 between the first antenna A1 or the second antenna A2 and the UWB tag T1 is known and the angle θ described above is obtained, a relative location of the UWB tag T1 with respect to the first antenna A1 and the second antenna A2 may be determined through the following Equation 2.

$$\frac{α}{2 π} = \frac{p}{λ} \\ θ = {sin}^{- 1} \frac{αλ}{2 π d} \qquad [ Equation 2 ]$$

Here, α denotes a phase difference between UWB signals received by the first transceiver and the second transceiver provided in the UWB anchor.

Meanwhile, in the present disclosure, one moving robot may follow a control device (or controller) or one of a plurality of moving robots which has a following (tracking, follow-up) relationship may follow another, through mutual communications. Also, the present disclosure has been realized to set, add and release such a following relationship easily and quickly.

Specifically, the moving robot according to the present disclosure calculates a signal distance when a first signal is received from the controller, and travels while following the location of the controller when the signal distance is within a predetermined range. Here, the first signal is a signal corresponding to an input given to a specific key provided on the controller, and refers to a control signal corresponding to a command to perform a following operation. In addition, the moving robot according to the present disclosure calculates a signal distance when a second signal is received from the controller while the following relationship is set with the controller, and releases the following relationship with the controller when the signal distance is within a predetermined range. Here, the second signal is a signal corresponding to an input different from the input corresponding to the first signal, and refers to a control signal corresponding to a command to release the following relationship.

According to this, any user who has the controller can set a following function quickly and easily so that a moving robot which is close to his/her location follows him/her. Also, the set following relationship can be immediately released or reset without complicated processes.

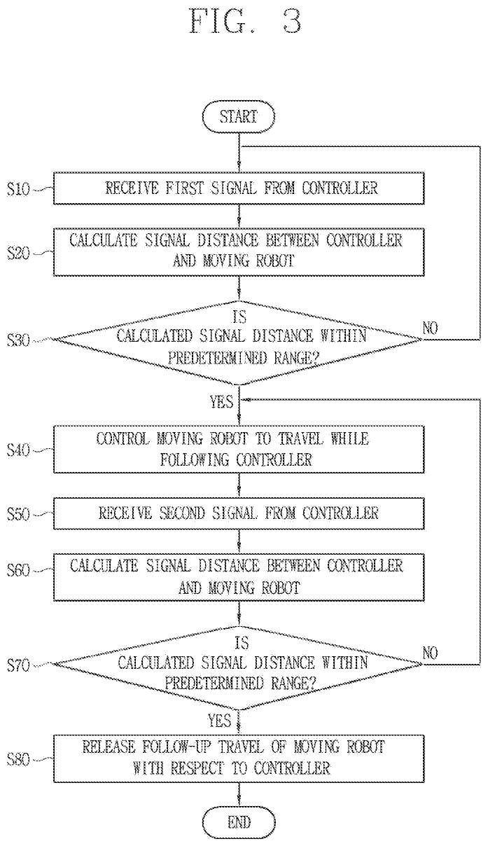

Hereinafter, a method of setting or releasing a following operation (state, relationship) of a moving robot will be described in more detail, with reference to FIGS. 3, 4A and 4B.

First, referring to FIG. 3, the moving robot 100 according to the present disclosure receives a first signal from a controller (control device) 200 which can communicate with the moving robot 100 (S10). Here, the first signal is an input signal which is applied to a first key provided on the controller 200, and configured to generate a control signal for setting following relationship.

To this end, the communication unit of the moving robot may receive the first signal using at least one of an Ultra-wideband (UWB) module and a Bluetooth (BT) module.

Next, the moving robot 100 calculates a signal distance between the controller and the moving robot based on the first signal (S20). Here, the calculation of the signal distance may be performed, for example, through a distance measuring sensor provided in the moving robot or the controller. In addition, the calculation of the signal distance may include signal angle calculation. To this end, at least the moving robot is equipped with a hardware configuration and a software program for applying the AoA positioning technology.

Next, the control unit of the moving robot 100 determines whether the calculated signal distance is within a predetermined range (S30). If the calculated signal distance is within the predetermined range, the control unit of the moving robot 100 controls the moving robot to move while following the controller (S40). Accordingly, a following (tracking) relationship is established between the controller and the moving robot.

To this end, in one example, the control unit of the moving robot controls the communication unit to transmit a response signal to the first signal to the controller when the calculated signal distance is within the predetermined range. When a third signal corresponding to a following command is received from the controller which has received the response signal, the control unit of the moving robot may control the moving robot to start a following travel at the time point when the third signal is received.

In this manner, when the following relationship is set, the control unit of the moving robot 100 communicates with the controller to continuously follow the location (position) of the controller. Here, the location of the controller refers to a relative position with respect to the current position of the moving robot.

Specifically, the communication unit of the moving robot may further include a plurality of antennas, and the control unit of the moving robot recognizes the position of the controller based on a first signal, which is received through the plurality of antennas and at least one of the UWB module and the BT module included in the communication unit. The control unit of the moving robot controls the traveling unit of the moving robot so that the moving robot can move while following the recognized position.

In relation to this, referring to FIG. 4A, the moving robot, for example, a smart cart 100 receives a signal a corresponding to an input applied to a specific key (e.g., a follow setting key) of the controller 200. The signal a includes a control signal corresponding to a command to follow the position of the controller 200.

The smart cart 100 that has received the signal a calculates a signal distance of the signal a, determines that the signal distance is within the predetermined range, and then transmits a response signal a′.

Specifically, when it is determined that the calculated signal distance is within the predetermined range, a positive acknowledgment is generated as the response signal a′ and is transmitted to the controller 200. The smart cart 100 continuously determines the position of the controller 200 by determining a distance and angle with respect to the controller 200, and travels while sequentially following a plurality of points corresponding to the position change of the controller 200. Accordingly, the user can put goods to buy into the cart during shopping, merely by keeping holding the controller, without having to pushing the cart by himself/herself.

On the other hand, when it is determined that the calculated signal distance is out of the predetermined range, a negative acknowledgment is generated as the response signal a′ and is transmitted to the controller 200, or any response is not made. Accordingly, the smart cart 100 does not follow the position of the controller.

In one example, when it is determined that the calculated signal distance is out of the predetermined range, guide information (e.g., Please come close and re-enter to execute ‘following function’) may be output in the form of voice, so that the controller 200 can generate an input signal by coming closer to the smart cart 100.

Also, the control unit of the moving robot 100 travels while varying a traveling direction and a traveling speed of the moving robot 100 depending on the relative position of the controller. For example, while the controller is staying in a specific position, the moving robot 100 may maintain a non-travel (stopped) state at a specific distance from the controller.

On the other hand, while the following relationship is established between the moving robot and the controller, the moving robot may receive a second signal from the controller (S50). Here, the second signal is an input signal which is applied to a second key provided on the controller 200, and configured to generate a control signal for releasing the set following relationship. Also, the second key may be a different button from the first key, a first key having a toggle function, or a combination key of the first key and the different button.

To this end, the communication unit of the moving robot may receive the first signal using at least one of a UWB module and a BT module.

Next, the moving robot 100 calculates a signal distance between the controller and the moving robot based on the second signal (S60). Here, the calculation of the signal distance may be performed, for example, through a distance measuring sensor provided in the moving robot or the controller. In addition, the calculation of the signal distance may include signal angle calculation. To this end, at least the moving robot is equipped with a hardware configuration and a software program for applying the AoA positioning technology.

The control unit of the moving robot 100 determines whether the calculated signal distance is within a predetermined range (S70). When the calculated distance is within the predetermined range, the control unit of the moving robot 100 controls the moving robot following the controller to stop the following travel (S80). That is, the following relationship between the moving robot and the controller is released.

In the regard, referring to FIG. 4B, in the state where the smart cart 100 is set to follow the controller 200, the smart cart 100 receives a signal b corresponding to an input applied to a specific key (e.g., a follow-up release key) of the controller 200. The signal b includes a control signal corresponding to a command to terminate the following function of the smart cart 100.

The smart cart 100 which has received the signal b may determine whether the signal has been received within a predetermined range by calculating the signal distance of the signal b, and then transmit a response signal. In this case, the predetermined range may be narrower more limited than the signal distance of a signal corresponding to the follow-up setting key. This can prevent the following travel from being released due to an erroneous input during shopping while holding the controller.

Alternatively, in another example, network communication when setting and releasing a following travel and network communication while performing a following function may be separately applied.

For example, at the moment of setting and releasing the following relationship, BT or NFC communication may be used so that the controller 200 performs an operation corresponding to a signal when it is located very close to the smart cart 100. And, UWB communication which covers a wider area may be used for determining a location after the following relationship is set.

When it is determined that the calculated signal distance is within the predetermined range, the following function of the smart cart 100 is terminated according to the signal b. Thereafter, the smart cart 100 neither determines the position of the controller 200, nor follows the controller 200 even if the controller 200 moves.

Meanwhile, although not shown, in a state in which following relationship is set between the controller and a moving robot, the following relationship with the mobile robot may also be released by transmitting the first signal to another moving robot without releasing the set following relationship. That is, at the time of setting following relationship with a second moving robot, following relationship set with a first moving robot may be automatically released.

In this manner, according to an embodiment of the present disclosure, it may be possible to quickly and easily set a function for making a moving robot follow a user who controls a controller and release the set following function.

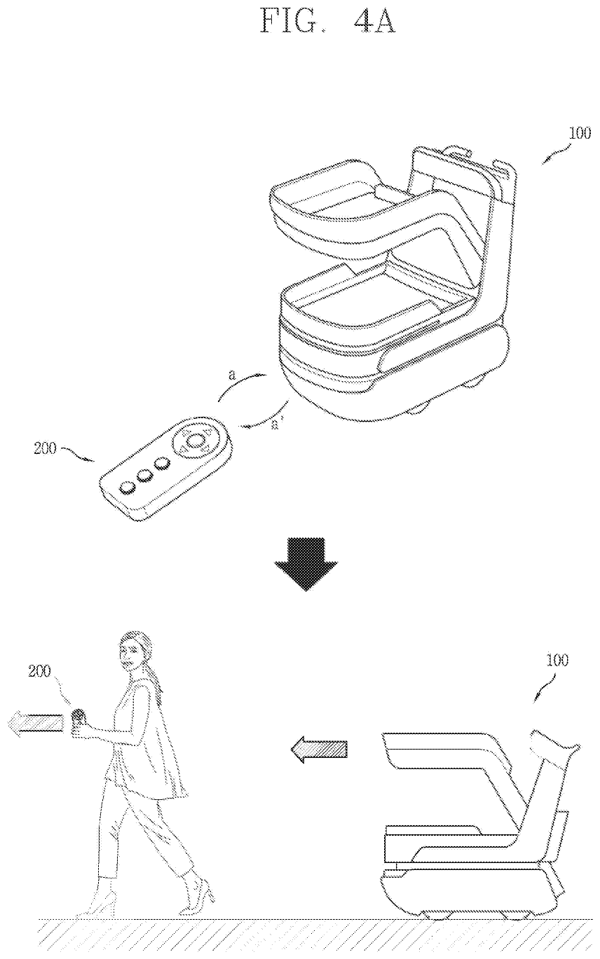

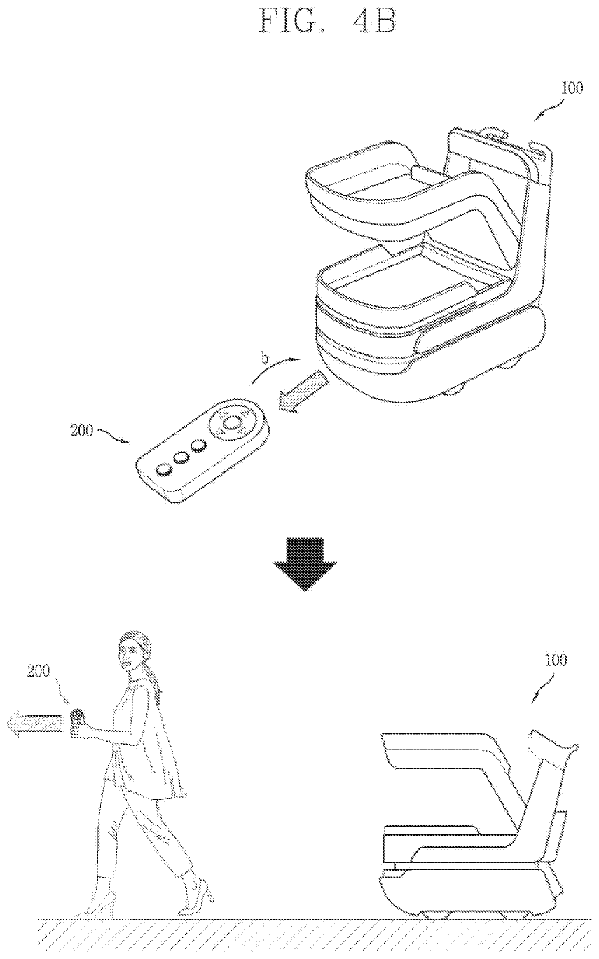

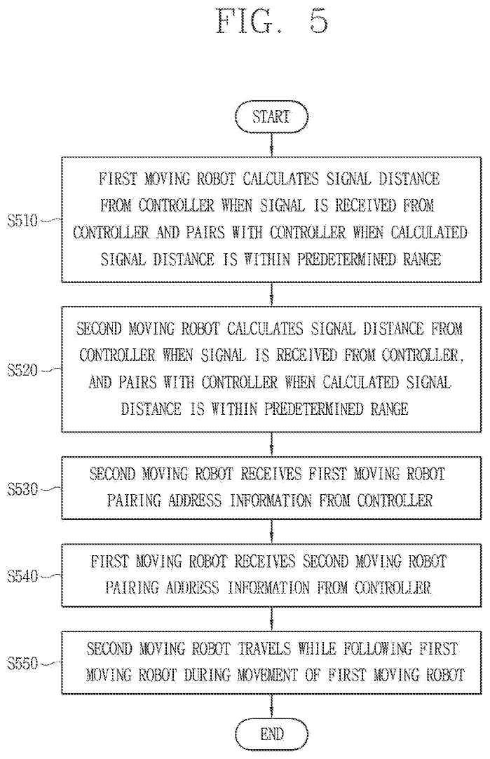

Hereinafter, with reference to FIGS. 5 and 6A to 6C, a method of setting following relationship among a plurality of moving robots using a controller will be described in detail as another embodiment of the present disclosure.

Each of a plurality of moving robots according to the present disclosure is configured to calculate both distance and angle during communications by applying the AoA technology. Further, the controller according to the present disclosure is configured to calculate at least a distance when performing communication with the plurality of moving robots. To this end, for example, the controller may include a BT module/UWB module, and each of the plurality of moving robots may include one UWB module and a plurality of antennas or may include a plurality of UWB modules.

Here, the plurality of antennas may be electrically connected to the BT module (or sensor) or the UWB module (or sensor) for transmitting and receiving signals, so as to transmit signals generated in the BT module (or sensor) or UWB module (or sensor) or receive signals from the exterior. The BT module (or sensor) or the UWB module (or sensor) may include various communication modules included in the communication unit of the moving robot, or may include various sensors included in the sensing unit 140 of the moving robot.

Also, the plurality of antennas may be configured to transmit and receive various signals. For example, the plurality of antennas may be configured to transmit and receive at least one of an Ultra-Wideband (UWB) signal, a signal output by one of wireless communication technologies (e.g., one of Zigbee, Z-wave, Blue-tooth, and UWB), an infrared signal, a laser signal, and an ultrasonic signal.

Referring to FIG. 5, when a first moving robot receives a signal from the controller, a signal distance between the first moving robot and the controller is calculated. When the calculated signal distance is within a predetermined range, the first moving robot performs pairing with the controller (S510). Here, the pairing may be defined as a process of allowing a plurality of devices using Bluetooth (BT) communication to operate in an interconnected state.

The controller may receive and store address information related to the first moving robot (hereinafter, referred to as ‘first moving robot pairing address information’) after pairing.

In this regard, referring to FIG. 6A, when the controller 200 is brought close to the first moving robot, for example, a first smart cart 100a. When an input is applied to a specific key (for example, a follow-up setting key), a control signal a corresponding to a command to pair the controller 200 with the first smart cart 100a is sent for setting following relationship.

Next, when a second moving robot receives a signal from the controller, a signal distance between the second moving robot and the controller is calculated. When the calculated signal distance is within a predetermined range, the second moving robot performs pairing with the controller (S520).

At this time, it should be noted that the first moving robot does not follow the controller while the controller moves to a position of the second moving robot in order to pair with the second moving robot.

The controller receives and stores address information related to the second moving robot (hereinafter, referred to as ‘second moving robot pairing address information) after pairing. Now, the controller stores the first moving robot pairing address information and the second moving robot pairing address information. Here, early-stored address information may be output first. To this end, a queue memory may be dynamically allocated, and the first moving robot pairing address information and the second moving robot pairing address information may be sequentially stored in the queue memory.

In this manner, after the pairing of the controller and the second moving robot is performed, the second moving robot receives the first moving robot pairing address information from the controller (S530). Then, the first moving robot receives the second moving robot pairing address information from the controller (S540).

To this end, the dynamically-allocated queue memory may be implemented such that two pairing address information are automatically output once they are stored. For example, when the pairing address of the first moving robot is stored and continuously the pairing address of the second moving robot is stored, the pairing address of the first moving robot may be output first and sequentially the pairing address of the second moving robot may be output in a first-in-first-out (FIFO) manner.

Alternatively, after the second moving robot is paired, if a preset input is applied to the controller, the plurality of pairing address information stored in the queue memory may be transferred to the first moving robot and the second moving robot, respectively, according to a preset order.

Further, the controller may transmit a command to the second moving robot so that the second moving robot starts communication for calculating the location of the first moving robot, in detail, a distance and/or angle. In addition, the controller may transmit a command to the first moving robot to periodically broadcast a beacon signal such as blink.

In this regard, referring to FIG. 6B, the controller 200 paired with the first smart cart 100a is brought close to a second moving robot, for example, a second smart cart 100b. When an input is applied to a specific key (e.g., follow-up setting key), a control signal corresponding to a command to pair the controller 200 with the second smart cart 100b for setting following relationship with the second smart cart 100b and a signal a+c corresponding to a pairing address of the first smart cart 100a are transmitted to the second smart cart 100b. The first smart cart 100a receives a signal d corresponding to the pairing address of the second smart cart 100b. At this time, the position of each of the first smart cart 100a and the second smart cart 100b must be within a communication range Dis in which they can communicate with each other.

In this manner, when the first smart cart 100a and the second smart cart 100b recognize their pairing addresses via the controller 200. When they exist in the designated communication range Dis, the second smart cart 100b moves while following the first smart cart 100a. At this time, the first smart cart 100a may autonomously travel or move while following the location of the controller 200.

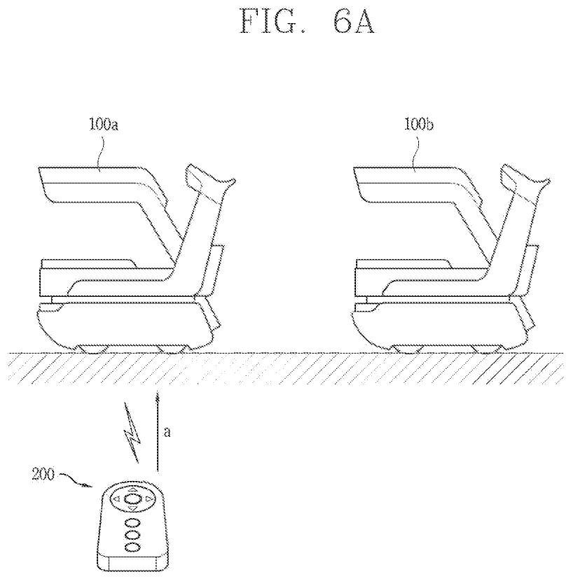

On the other hand, the follow-up control of the plurality of moving robots will be described in detail with reference to FIGS. 7A to 7C. It is noted that this can be applied not only to the follow-up control between the plurality of moving robots but also to a case where one moving robot travels while following a controller.

The control unit of the moving robot according to the present disclosure may control the set following relationship to be released when the signal distance between the moving robot and the controller or another moving robot exceeds a preset threshold following distance while the moving robot follows the controller or the another moving robot. Here, the preset threshold following distance may be defined as a maximum distance at which communication can be performed.

In addition, when the signal distance between the moving robot and the controller or the another moving robot is reduced into a preset threshold stop distance while the moving robot follows the controller or the another moving robot, the moving robot may be stopped until the signal distance exceeds the preset threshold stop distance. Here, the preset threshold stop distance may be defined as a minimum distance which must be maintained between the moving robot and the controller (gripped by the user) or the another moving robot for safe travel of the moving robot.

On the other hand, when approaching or reaching the preset threshold following distance or the preset threshold stop distance, the moving robot may output a preset beep sound or a guidance voice through the output unit.

In one embodiment, the moving robot following the controller or the second moving robot following the first moving robot may change a traveling speed so as not to deviate from (exceed) the preset threshold following distance or output guidance information for guiding the controller or the first moving robot which is moving ahead to stop/slowly move.

(a) of FIG. 7A shows a case where a spaced distance D1 between the first moving robot 100a and the second moving robot 100b does not satisfy a threshold stop distance at the moment but is determined to reach or become shorter than the threshold stop distance soon based on current traveling speeds V1 and V0 of the first moving robot 100a and the second moving robot 100b.

At this time, as illustrated in (b) of FIG. 7A, the traveling speed of the first moving robot 100a is changed by adding the current traveling speed V1 with a value (+), which is obtained by subtracting a predicted spaced distance from the threshold stop distance. Accordingly, the first moving robot 100a travels at a traveling speed V2 faster than before (V1), and thus the distance D1 between the first moving robot 100a and the second moving robot 100b is increased to a distance D2.

Next, (a) of FIG. 7B shows a case where a spaced distance D3 between the first moving robot 100a and the second moving robot 100b does not reach or exceed a threshold following distance at the moment but is determined to reach or exceed the threshold following distance soon based on the current traveling speeds V1 and V0 of the first moving robot 100a and the second moving robot 100b.

At this time, as illustrated in (b) of FIG. 7B, the traveling speed of the first moving robot 100a is changed by adding the current traveling speed V1 with a value (−), which is obtained by subtracting a predicted spaced distance from the threshold following distance. Accordingly, the first moving robot 100a travels at a traveling speed V3 slower than before (V1), and thus the distance D3 between the first moving robot 100a and the second moving robot 100b is decreased to a distance D4.

Here, the decelerated traveling speed V3 may include “0”. For example, when the traveling speed of the second moving robot 100b is further reduced, or when the spaced distance D3 between the first moving robot 100a and the second moving robot 100b is about to exceed the threshold following distance, the first moving robot 100a may be controlled to be stopped.

Next, (a) of FIG. 7C shows a case where a spaced distance D5 between the first moving robot 100a and the second moving robot 100b is determined to reach a threshold stop distance soon as similar to FIG. 7A, but the first moving robot 100a is unable to travel faster due to a surrounding situation.

At this time, as illustrated in (b) of FIG. 7C, the first moving robot 100a may transmit a stop command to the second moving robot 100b while maintaining its traveling speed. After a predetermined period of time elapses, when a spaced distance D6 between the first moving robot 100a and the second moving robot 100b increases, the first moving robot 100a may transmit an operation command to the second moving robot 100b so that the second moving robot 100b can keep following it.

On the other hand, in the case where a traveling path of the second moving robot 100b is changed to be different from a traveling path of the first moving robot 100a depending on a surrounding situation, when the changed traveling path becomes farther away from the spaced distance between the second moving robot 100b and the first moving robot 100a, the first moving robot 100a may receive related status information and decelerate its traveling speed or stop for a predetermined time so that the second moving robot can keep following it.

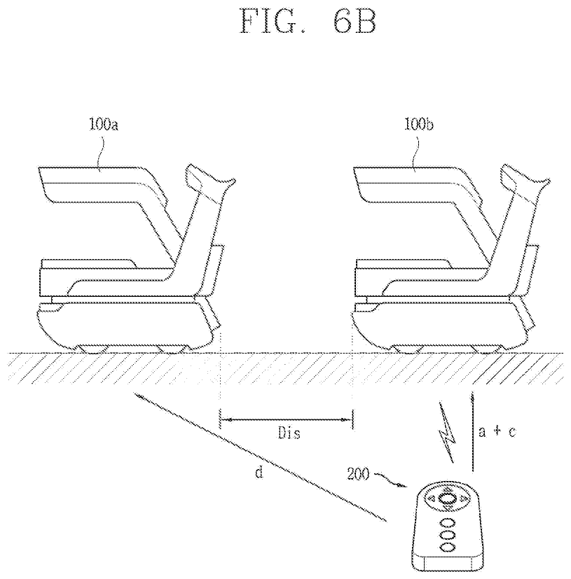

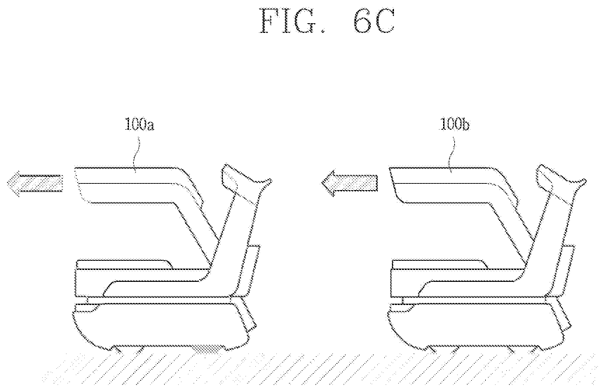

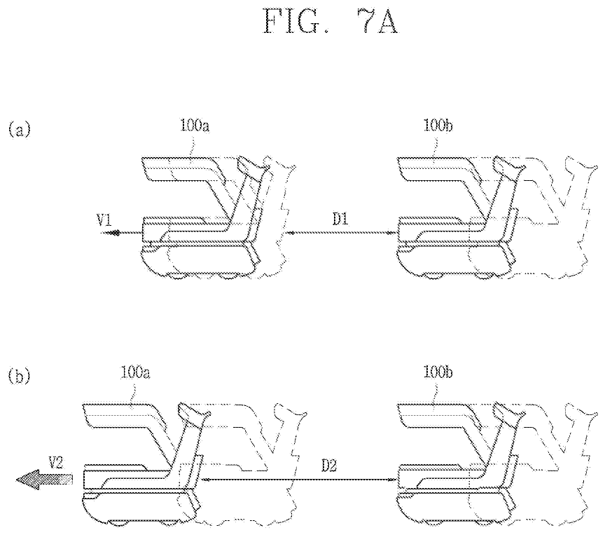

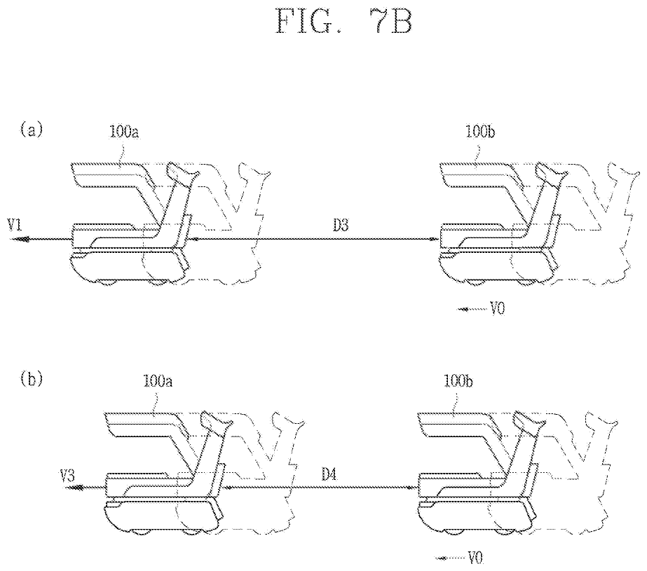

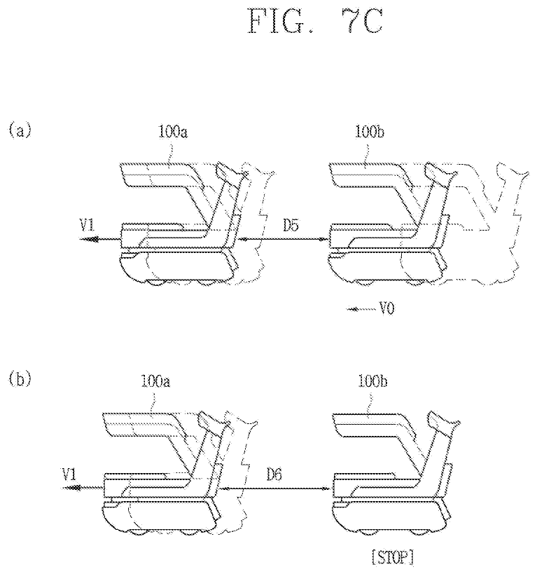

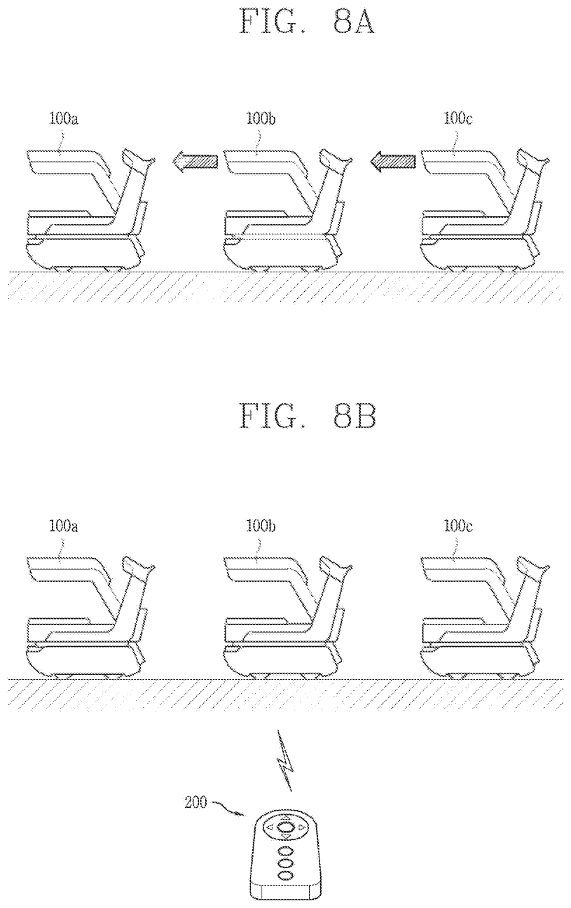

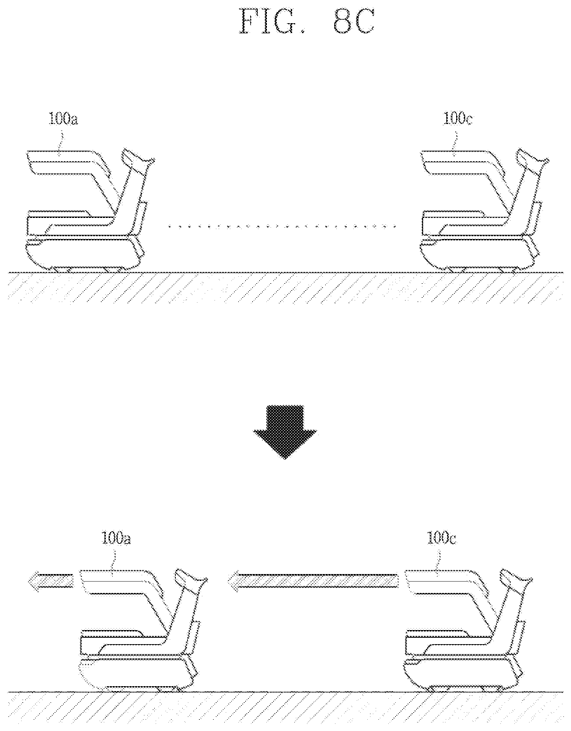

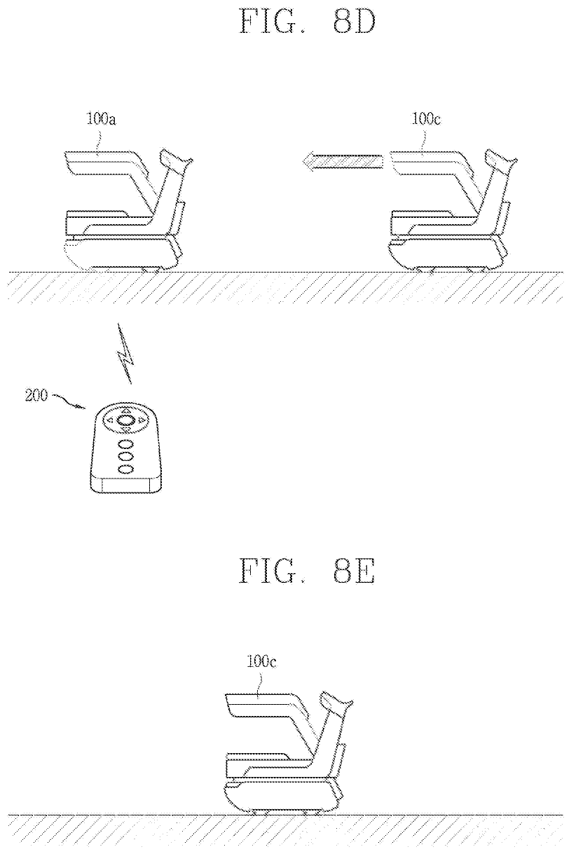

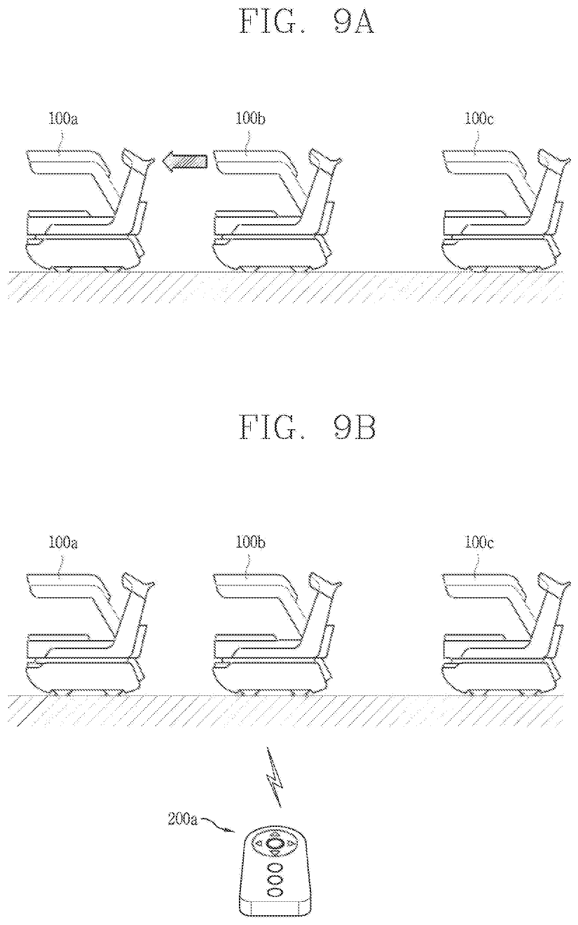

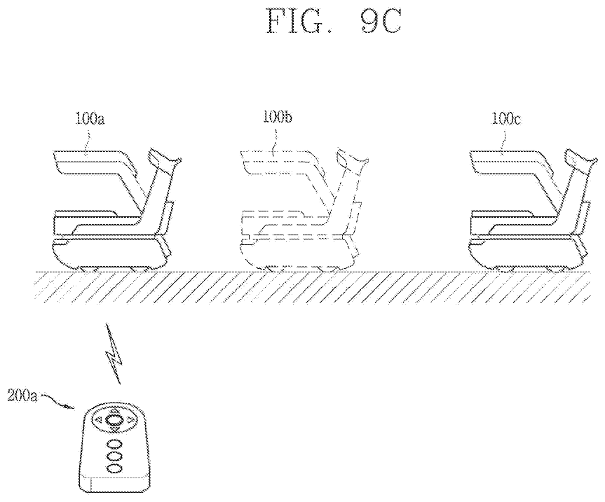

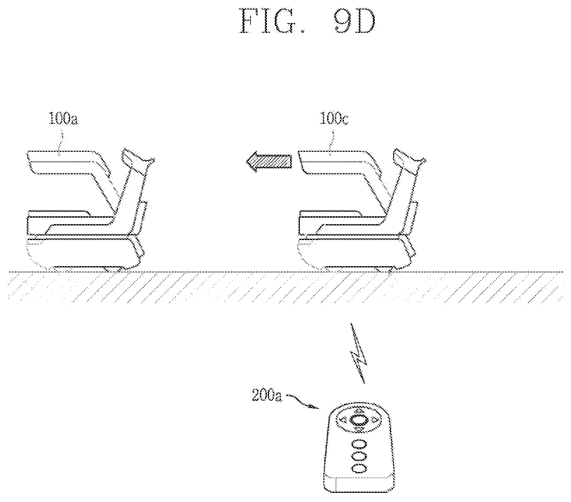

Hereinafter, different examples of releasing following relationship of at least some of three or more moving robots which are set to sequentially follow one another will be described with reference to FIGS. 8A to 8E and FIGS. 9A to 9D.

First, a method for setting a following travel of a third moving robot in a state where following relationship has been established between a plurality of moving robots will be described. As described above, while the second moving robot is following the first moving robot according to following relationship set between the first moving robot and the second moving robot, a third moving robot for which following relationship is to be set receives a signal (hereinafter, referred to as ‘third signal’) from the controller 200. Here, the signal is an input signal corresponding to an input given to a specific key of the controller 200, and refers to a control signal corresponding to a command to make the third moving robot follow the second moving robot whose following travel has been set immediately before.

Accordingly, in order for the third moving robot to sequentially follow the second moving robot which is following the first moving robot, a condition should be satisfied that the third moving robot receives the third signal within a predetermined time (for example, within 5 seconds) after the following travel of the second moving robot is set.

When the third signal is received, the third moving robot calculates a signal distance up to (between the third moving robot and) the controller 200. When the calculated signal distance is within the predetermined range, the third moving robot is paired with the controller. Then, the third moving robot receives pairing address information regarding the second moving robot from the controller 200, and moves while following the second moving robot. At the same time, the second moving robot also receives pairing address information regarding the third moving robot from the controller 200, so that communication can be performed between the second moving robot and the third moving robot.

Accordingly, as illustrated in FIG. 8A, the second moving robot 100b continues to move while following the first moving robot 100a, and the newly added third moving robot 100c moves while following the second moving robot 100b which is moving ahead of it. If it is assumed that the first moving robot 100a has been set to follow the controller 200, once the user moves to a target place while gripping the controller 200, the first, second, and third moving robots 100a, 100b, and 100c sequentially follow the controller 200.

In this manner, even if the third moving robot is added, since the following relationship is performed (set) between the first moving robot and the second moving robot, and between the second moving robot and the third moving robot, any number of moving robots can be added easily. In addition, visual and control aspects are not complicated, and satisfaction of use can be improved.

Hereinafter, an example of releasing following relationship of some of three or more moving robots in a state where those three or more moving robots are in following relationship will be described, with reference to FIGS. 8B to 8E.

As illustrated in FIG. 8A, while the second moving robot 100b is following the first moving robot 100a and the third moving robot 100c is following the second moving robot 100b, a specific moving robot, for example, the second smart cart (second moving robot) 100b may receive a second signal, namely, a signal corresponding to a command to release the following relationship from the controller 200 through mutual communication (UWB/BT communication).

Then, the second moving robot calculates a signal distance between the controller and it based on the second signal. When the calculated signal distance is within a predetermined range, the following travel of the second moving robot with respect to the first moving robot is released.

At this time, as described above, the signal distance for performing the operation corresponding to the first signal (‘follow-up setting signal’) and the signal distance for performing the operation corresponding to the second signal (‘follow-up release signal’) may be different from each other. For example, in order to prevent a follow-up release due to an erroneous input, the signal distance for performing the operation corresponding to the follow-up release signal may be shorter than the signal distance for performing the operation corresponding to the follow-up setting signal.

As such, when the follow-up setting for the second moving robot positioned in the middle is released while the first to third moving robots are in the following relationship, the second moving robot 100b, i.e., the second smart cart 100b, transfers pairing address information regarding the first moving robot, namely, the first smart cart 100a to the third moving robot, namely, the third smart cart 100c. Also, the second smart cart 100b transmits the pairing address information regarding the third smart cart 100c stored therein to the first smart cart 100a.

Accordingly, the first smart cart 100a and the third smart cart 100c perform communication with each other simultaneously when or after the follow-up setting for the second smart cart 100b is released, and as illustrated in FIG. 8C, the third smart cart 100c then moves while following the first smart cart 100a.

At this time, although not illustrated, when the first smart cart 100a and the third smart cart 100c are spaced far apart from each other, the first smart cart 100a may start to travel after the third smart cart 100c moves close to the first smart cart 100a to enable communication with the first smart cart 100a (e.g., after the third smart cart 100c moves toward the first smart cart 100a so that the distance between the first smart cart 100a and the third smart cart 100c becomes the threshold stop distance). Then, the third smart cart 100c may move while following the position of the first smart cart 100a.

Next, an operation when the pairing of a leading moving robot in the following relationship is released will be described. Referring to FIG. 8D, while the third smart cart 100c is following the first smart cart 100a, the first smart cart 100a receives the second signal, namely, the follow-up release signal, from the controller 200. Then, the first smart cart 100a calculates a signal distance between the controller 200 and it. When the calculated signal distance is within a predetermined range, the pairing of the first smart cart 100a may be released. In this manner, when the pairing of the first smart cart 100a is released, the following function of the third smart cart 100c is also automatically released. Accordingly, as illustrated in FIG. 8E, the travel of the third smart cart 100c can be stopped.

Even if the follow-up setting is released for a specific moving robot located in the middle in a state where the following relationship is set among three or more moving robots, the leading moving robot and a moving robot succeeding the specific moving robot may be connected to communicate with each other, thereby continuing the follow-up control.

However, in another embodiment, when the follow-up setting for the specific moving robot located in the middle is released in the state where the following relationship is set among the three or more moving robots, the following relationship is separated (divided into two parts) or all the following relationship may be released.

On the other hand, FIGS. 9A to 9D illustrate an example of changing a target, which is to perform a following travel among a plurality of moving robots. First, referring to FIG. 9A, in a state where the second smart cart 100b is set to follow the first smart cart 100, when it is desired to change a cart to follow the first smart cart 100a, as illustrated in FIG. 9B, the controller 200 is moved close to the second smart cart 100b to transmit the second signal to the second smart cart 100b, thereby releasing the follow-up setting of the second smart cart 100b.

Afterwards, as illustrated in FIG. 9C, the controller 200 is moved close to the first smart cart 100a, which is to be designated as a leading cart (the head) in the following relationship, to transmit the first signal, that is, the follow-up setting signal, to the first smart cart 100a. Then, as illustrated in FIG. 9D, the controller 200 is moved close to the third smart cart 100c, which is to be designated as a following robot, to transmit the first signal, that is, the follow-up setting signal, to the third smart cart 100c. Then, the following relationship is established between the first smart cart 100a and the third smart cart 100c, and the third smart cart 100c then moves while following the first smart cart 100a.

Meanwhile, although not illustrated, the third smart cart 100c may be designated as the leading robot after releasing the follow-up setting of the second smart cart 100b. In this case, the controller 200 first comes close to the third smart cart 100c to transmit the first signal to the third smart cart 100c, and then comes closer to the first smart cart 100a to transmit the first signal to the first smart cart 100a. Accordingly, the first smart cart 100a moves while following the third smart cart 100c.

On the other hand, the moving robot (or smart cart) may be replaced with another moving device. Here, the moving device 100 may not have a carrying function. In addition, any electronic device may be included as long as it has a traveling function. For example, the moving device 100 may include various types of home appliances or other electronic devices, such as a dehumidifier, a humidifier, an air purifier, an air conditioner, a smart TV, an artificial intelligent speaker, a digital photographing device, and the like, with no limit.

As described above, in a moving robot and a follow-up setting method thereof according to an embodiment of the present disclosure, it may be possible to quickly and easily set a function for making a moving robot follow a user who controls a controller and release the set following function. Even if a third moving robot is added in a state where following relationship is established among a plurality of moving robots, the following relationship is performed (established) between a first moving robot and a second moving robot, and between the second moving robot and the third moving robot, which may facilitate an additional follow-up setting for any number of moving robots. Further, follow-up setting for a part of a plurality of moving robots which are in following relationship can be released or a target or order to follow in the set following relationship can be changed quickly and easily.

The present disclosure described above can be implemented as computer-readable codes on a program-recorded medium. The computer-readable medium may include all types of recording devices each storing data readable by a computer system. Examples of the computer-readable medium include a hard disk drive (HDD), a solid state disk (SSD), a silicon disk drive (SDD), a ROM, a RAM, a CD-ROM, a magnetic tape, a floppy disk, an optical data storage device and the like, and may also be implemented in the form of a carrier wave (e.g., transmission over the Internet). In addition, the computer may also include the control unit 180. The above detailed description should not be limitedly construed in all aspects and should be considered as illustrative. The scope of the present disclosure should be determined by rational interpretation of the appended claims, and all changes within the scope of equivalents of the present disclosure are included in the scope of the present disclosure.

What is claimed is:

1. A moving robot, comprising:
a traveling unit to move a main body thereof;
a communication unit to perform communication with a controller using signals; and
a control unit to calculate a signal distance between the controller and the main body in response to reception of a first signal from the controller, and control the traveling unit so that the main body moves while following the controller when the calculated signal distance is within a predetermined range,
wherein the control unit calculates a signal distance between the controller and the main body in response to reception of a second signal from the controller while the main body is following the controller, and releases the follow-up travel of the main body when the calculated signal distance is within a predetermined range.

2. The moving robot of claim 1, wherein the communication unit receives the first signal and the second signal using at least one of an Ultra-wideband (UWB) module and a Bluetooth (BT) module.

3. The moving robot of claim 2, wherein the communication unit further comprises a plurality of antennas, and
wherein the control unit recognizes a position of the controller based on the first signal received through at least one of the UWB module and the BT module and the plurality of antennas, and controls the traveling unit to move while following the recognized position.

4. The moving robot of claim 1, wherein the control unit controls the communication unit to transmit a response signal to the first signal to the controller when the calculated signal distance is within the predetermined range, and
starts the follow-up travel of the main body, in response to reception of a third signal corresponding to a follow-up command from the controller that has received the response signal.

5. The moving robot of claim 1, wherein the control unit releases the follow-up travel of the main body when the signal distance between the main body and the controller exceeds a preset threshold distance while the main body is following the controller.

6. The moving robot of claim 5, wherein the control unit stops the travel of the main body until the signal distance between the main body and the controller exceeds a predetermined stop distance, in response to the signal distance being reduced to be shorter than the predetermined stop distance, while the main body is following the controller.

7. A plurality of moving robots comprising a first moving robot and a second moving robot that perform communication with a controller using signals,
wherein the first moving robot calculates a signal distance from the controller in response to reception of a signal from the controller, and pairs with the controller when the calculated signal distance is within a predetermined range,
wherein the second moving robot calculates a signal distance from the controller in response to reception of a signal from the controller, pairs with the controller when the calculated signal distance is with a predetermined range, and receives pairing address information regarding the first moving robot from the controller, so as to move while following the first moving robot, and
wherein the first moving robot receives pairing address information regarding the second moving robot from the controller, so as to perform communication with the second moving robot after pairing with the second moving robot.

8. The plurality of moving robots of claim 7, wherein the first moving robot is restricted from following the controller while the controller is moving toward the second moving robot after the first moving robot and the controller are paired.

9. The plurality of moving robots of claim 7, wherein the first moving robot periodically broadcasts a beacon signal to perform communication with the second moving robot, after receiving the pairing address information regarding the second moving robot from the controller.

10. The plurality of moving robots of claim 7, wherein a third moving robot calculates a signal distance from the controller upon receiving a signal from the controller while the second moving robot is following the first moving robot, pairs with the controller when the calculated signal distance is within a predetermined range, and receives pairing address information regarding the second moving robot from the controller, so as to move while following the second moving robot, and
wherein the second moving robot receives pairing address information regarding the third moving robot from the controller.

11. The plurality of moving robots of claim 10, wherein the second moving robot calculates a signal distance from the controller when a second signal is received from the controller while the third moving robot is following the second moving robot and the second moving robot is following the first moving robot, and releases the follow-up travel of the second moving robot with respect to the first moving robot when the calculated signal distance is within a predetermined range.

12. The plurality of moving robots of claim 11, wherein the second moving robot, when the follow-up travel of the second moving robot is released, transmits pairing address information regarding the first moving robot to the third moving robot, and transfers the pairing address information regarding the third moving robot to the first moving robot, and
wherein the third moving robot moves while following the first moving robot when a signal distance between the first moving robot and the third moving robot is within a predetermined range.

13. The plurality of moving robots of claim 7, wherein the first moving robot calculates a signal distance from the controller upon receiving a second signal from the controller, and releases pairing of the first moving robot when the calculated signal distance is within a predetermined range, and
wherein the follow-up travel of the second moving robot with respect to the first moving robot is released when the pairing of the first moving robot is released.

14. A method for controlling a moving robot capable of communicating with a controller, the method comprising:
receiving a first signal from the controller;
calculating a signal distance between the controller and the moving robot;
controlling the moving robot to move while following the controller when the calculated signal distance is within a predetermined range;
receiving a second signal from the controller while the moving robot is following the controller;
calculating a signal distance between the controller and the moving robot; and
controlling the follow-up travel of the moving robot to be released when the calculated signal distance is within a predetermined range.

15. A method for controlling a plurality of moving robots including a first moving robot and a second moving robot that communicate with a controller using signals, the method comprising:
calculating, by the first moving robot, a signal distance from the controller in response to reception of a signal from the controller, and performing pairing with the controller when the calculated signal distance is within a predetermined range;
calculating, by the second moving robot, a signal distance from the controller in response to reception of a signal from the controller, and performing pairing with the controller when the calculated signal distance is within a predetermined range;
receiving, by the second moving robot, pairing address information regarding the first moving robot from the controller so that the second moving robot moves while following the first moving robot;
receiving, by the first moving robot, pairing address information regarding the second moving robot from the controller, so as to perform communication with the second moving robot; and
moving, by the second moving robot, while following the first moving robot when the first moving robot moves.
